(19) United States
(12) Patent Application Publication
(10) Pub. No.: US 2024/0391813 A1
(43) Pub. Date: Nov. 28, 2024

(54) APPARATUS FOR FORMING MOLTEN GLASS WITH STRUCTURALLY REINFORCED CONDUITS

(71) Applicant: CORNING INCORPORATED, CORNING, NY (US)

(72) Inventors: Gilbert De Angelis, Lindley, NY (US); Juan Camilo Isaza, Corning, NY (US); Christopher Myron Smith, Corning, NY (US)

(21) Appl. No.: 18/696,047

(22) PCT Filed: Sep. 28, 2022
(86) PCT No.: PCT/US2022/044972

§ 371 Date: Mar. 27, 2024

Related U.S. Application Data
(60) Provisional application No. 63/257,778, filed on Oct. 20, 2021.

(51) Int. Cl. C03B 5/167

(52) U.S. Cl. CPC C03B 5/1675

(57) ABSTRACT

A glass manufacturing apparatus comprising a conduit defining an interior passage for conveying molten glass, the conduit including at least one reinforcing member disposed about and attached to at least a portion of an exterior periphery of the conduit.

### CROSS-REFERENCE TO RELATED APPLICATIONS

This application claims the benefit of priority under 35 U.S.C. § 119 of U.S. Provisional Application Ser. No. 63/257,778, filed on Oct. 20, 2021, the content of which is relied upon and incorporated herein by reference in its entirety.

### FIELD

The present disclosure relates to apparatus for forming molten glass, and more particularly to conduits for conveying the molten glass wherein the conduits include reinforcing members to prevent collapse of the conduit.

### BACKGROUND

Manufacturing apparatus for forming molten glass typically include conduits configured to convey the molten glass from one station of the apparatus to another station. For example, a conduit can extend between a melting vessel and a downstream component such as a stirring vessel. Because of the high temperature and corrosive nature of molten glass, many components of the manufacturing apparatus are formed from temperature and corrosion resistant metals, often selected from the platinum groups metals. These components are often thin-walled owing to the expense of these metals. For certain glasses, processing temperatures can be near the melting temperature of the metal. Because the metal may be very thin, the component structures may therefore lack significant strength and be prone to collapse over time.

### SUMMARY

In a first aspect, a glass forming apparatus is disclosed, comprising: a conduit comprising a metal conduit wall defining an interior passage of the conduit, the conduit configured to carry a flow of molten glass through the interior passage; and at least one reinforcing member extending around at least a portion of an external periphery of the conduit and attached to the metal conduit wall, the at least one reinforcing member positioned between and spaced apart from a pair of adjacent electrical flanges.

In a second aspect, the at least one reinforcing member of the first aspect may extend across at least an upper portion of the metal conduit wall.

In a third aspect, the at least one reinforcing member of the first aspect or the second aspect may extend circumferentially around the conduit.

In a fourth aspect, the at least one reinforcing member of any of the first through the third aspects may comprise a plurality of reinforcing members.

In a fifth aspect, the at least one reinforcing member of any of the first through the fourth aspects may comprise a hollow interior.

In a sixth aspect, the at least one reinforcing member of any of the first through the fifth aspects may comprise a pressure equalization orifice providing fluid communication between the hollow interior and an atmosphere external to the reinforcing member hollow interior.

In a seventh aspect, the metal conduit wall of any of the first through the sixth aspects, may comprise platinum.

In an eighth aspect, the at least one reinforcing member according to any of the first through the seventh aspect may comprise platinum.

In a ninth aspect, the glass forming apparatus according to any of the first to the eighth aspect may be a fining vessel.

In a tenth aspect, the at least one reinforcing member of any of the first to the ninth aspect may be attached to the conduit by plates.

In an eleventh aspect, the at least one reinforcing member of the tenth aspect may be spaced apart from the conduit by a gap.

In a twelfth aspect, a cross-sectional shape of the at least one reinforcing member of any of the first aspect through the eleventh aspect may be rectangular or circular.

In a thirteenth aspect, a glass forming apparatus is described, comprising: a fining vessel comprising a metal wall defining an interior passage of the fining vessel, the fining vessel configured to carry a flow of molten glass through the interior passage; and at least one reinforcing member extending around at least a portion of an external periphery of the fining vessel and attached to the metal wall, the at least one reinforcing member positioned between and spaced apart from a pair of adjacent electrical flanges.

In a fourteenth aspect, the at least one reinforcing member of the thirteenth aspect may extend circumferentially around the fining vessel.

In a fifteenth aspect, the metal wall of the fourteenth aspect or the fifteenth aspect may comprise platinum.

In a sixteenth aspect, the at least one reinforcing member of any of the thirteenth to the fifteenth aspect may comprise platinum.

In a seventeenth aspect, the at least one reinforcing member of any of the thirteenth aspect to the sixteenth aspect may comprise a hollow interior.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is a schematic view of an exemplary glass manufacturing apparatus;

FIG. 2 provides cross sectional views of a conduit for conveying molten glass as (a) initially placed in service, (b) after time operating at high temperature wherein an upper portion of the conduit undergoes collapse, and (c) wherein collapse is sufficiently large to cause the collapsed top of the conduit to contact the free surface of the molten glass therein, effectively isolating an airspace at one end of the conduit from an airspace at another end of the conduit;

FIG. 3 is a longitudinal cross-sectional view of the conduit of FIG. 2 (a):

FIG. 4 is a cross-sectional view of an exemplary conduit, e.g., fining vessel, showing reinforcing members attached around the conduit:

FIG. 5 is a perspective view of an exemplary conduit showing reinforcing members disposed completely around the conduit:

FIG. 6 is a perspective view of another exemplary conduit showing reinforcing members disposed partially about the conduit:

FIG. 7 is a cross-sectional view of an exemplary conduit showing a reinforcing member disposed partially about the conduit and the angle α subtended by the reinforcing members relative to top dead center (TDC) of the conduit:

FIG. 8 depicts various cross-sectional views of exemplary hollow reinforcing members attached to a conduit wall, including (a) a channel, (b) a box, (c) a cylindrical tube attached with plates with no gaps between the cylindrical tube and the conduit wall, (d) a cylindrical tube attached with plates with a gap between the cylindrical tube and the conduit wall, and (e) a cylindrical tube attached without plates:

FIG. 9 depicts various cross-sectional views of exemplary solid reinforcing members attached to a conduit wall, including (a) a square member, (b) a cylindrical bar attached with plates with no gaps between the cylindrical bar and the conduit wall, (c) a cylindrical bar attached with plates with a gap between the cylindrical tube and the conduit wall, (d) a cylindrical bar attached without plates, (e) a “T”-shaped reinforcing member, and (f) an “I” shaped reinforcing member:

FIG. 10 is a perspective view of a portion of a conduit illustrating a reinforcing member comprising pressure equalization orifices and paired with a crease (crimp) in a wall of the conduit:

FIG. 11 is an elevational cross-sectional view of an exemplary conduit (e.g., fining vessel) enclosed by refractory support materials:

FIG. 12A is a perspective view of a modeled temperature distribution for an exemplary conduit (e.g., fining vessel) without reinforcing members and direct heated by electrical flanges:

FIG. 12B is a perspective view of a modeled temperature distribution for the exemplary conduit (e.g., fining vessel) of FIG. 12A with reinforcing members and direct heated by electrical flanges:

FIG. 13A is a perspective view of a modeled electrical current density distribution for an exemplary conduit (e.g., fining vessel) without reinforcing members and direct heated by electrical flanges; and

FIG. 13B is a perspective view of a modeled electrical current density distribution for the exemplary conduit (e.g., fining vessel) of FIG. 13A with reinforcing members and direct heated by electrical flanges.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure can be embodied in many different forms and should not be construed as limited to the embodiments set forth herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint.

Directional terms as used herein—for example, up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic with respect to arrangement of steps, operational flow, order of components, or orientation of components: plain meaning derived from grammatical organization or punctuation, and: the number or type of embodiments described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including,” and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the term conduit refers generally to a structure defining a hollow interior configured to convey molten glass therethrough. Conduits may be configured for conveyance purposes or structured to perform additional functions. For example, structures configured for removing gases from molten glass, although referred to as fining vessels herein, nevertheless belong generically to the family of conduits.

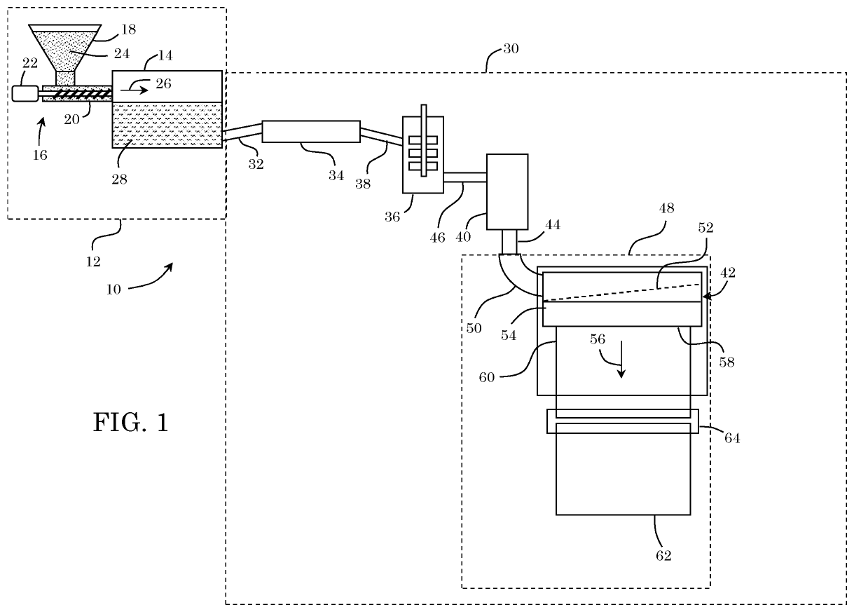

Shown in FIG. 1 is an exemplary glass manufacturing apparatus 10. The glass manufacturing apparatus 10 comprises a glass melting furnace 12 including a melting vessel 14. In addition to melting vessel 14, glass melting furnace 12 can optionally include one or more additional components such as heating elements (e.g., combustion burners and/or electrodes) configured to heat raw material and convert the raw material into a molten material, hereinafter, molten glass. For example, melting vessel 14 may be an electrically boosted melting vessel, wherein energy is added to the raw material through both combustion burners and by direct heating, wherein an electrical current is passed through the raw material, the electrical current thereby adding energy via Joule heating of the raw material.

Glass melting furnace 12 may include other thermal management devices (e.g., thermal insulation components) that reduce heat loss from the melting vessel. Glass melting furnace 12 can include electronic and/or electromechanical devices that facilitate melting of the raw material into a glass melt. Glass melting furnace 12 can include support structures (e.g., support chassis, support member, etc.) or other components.

Melting vessel 14 may be formed from a refractory material, for example a refractory ceramic material comprising alumina or zirconia, although the refractory ceramic material can comprise other refractory materials, such as yttrium (e.g., yttria, yttria-stabilized zirconia, yttrium phosphate), zircon (ZrSiO₄) or alumina-zirconia-silica or even chrome oxide, used either alternatively or in any combination. In some examples, melting vessel 14 may be constructed from refractory ceramic bricks.

Glass melting furnace 12 may be incorporated as a component of a glass manufacturing apparatus configured to fabricate a glass article, for example a glass ribbon, although the glass manufacturing apparatus can be configured to form other glass articles without limitation, such as glass rods, glass tubes, glass envelopes (for example, glass envelopes for lighting devices, e.g., light bulbs) and glass lenses. In some examples, melting furnace 12 may be included in a glass manufacturing apparatus comprising a slot draw apparatus, a float bath apparatus, a down-draw apparatus (e.g., a fusion down draw apparatus), an up-draw apparatus, a pressing apparatus, a rolling apparatus, a tube drawing apparatus or any other glass manufacturing apparatus that would benefit from the present disclosure. By way of example, FIG. 1 schematically illustrates glass melting furnace 12 as a component of a fusion down-draw glass manufacturing apparatus 10 for fusion drawing a glass ribbon for subsequent processing into individual glass sheets or rolling the glass ribbon onto a spool. As used herein, fusion drawing comprises flowing molten glass over inclined, e.g., converging, side surfaces of a forming body, wherein the resulting streams of molten material join, or “fuse,” at the bottom of the forming body to form a ribbon.

Glass manufacturing apparatus 10 may optionally include an upstream glass manufacturing apparatus 16 positioned upstream of melting vessel 14. In some examples, a portion of, or the entire upstream glass manufacturing apparatus 16, can be incorporated as part of the glass melting furnace 12.

As shown in FIG. 1, upstream glass manufacturing apparatus 16 may include a raw material storage bin 18, a raw material delivery device 20, and a motor 22 connected to raw material delivery device 20. Raw material storage bin 18 can be configured to store raw material 24 that can be fed into melting vessel 14 of glass melting furnace 12 through one or more feed ports, as indicated by arrow 26. Raw material 24 typically comprises one or more glass forming metal oxides and one or more modifying agents. In some examples, raw material delivery device 20 can be powered by motor 22 to deliver a predetermined amount of raw material 24 from raw material storage bin 18 to melting vessel 14. In further examples, motor 22 can power raw material delivery device 20 to introduce raw material 24 at a controlled rate based on a level of molten glass sensed downstream from melting vessel 14 relative to a flow direction of the molten glass. Raw material 24 within melting vessel 14 may thereafter be heated to form molten glass 28. Typically, the raw material is added to the melting vessel as particulate, for example as various “sands.” Raw material 24 can also include scrap glass (i.e., cullet) from previous melting and/or forming operations. Combustion burners can be used to begin the melting process. In an electrically boosted melting process, once the electrical resistance of the raw material is sufficiently reduced by the combustion burners, electric boost can begin by developing an electrical potential between electrodes positioned in contact with the raw material, thereby establishing an electrical current through the raw material, the raw material typically entering, or in, a molten state.

Glass manufacturing apparatus 10 may also include a downstream glass manufacturing apparatus 30 positioned downstream of glass melting furnace 12 relative to a flow direction of molten glass 28. In some examples, a portion of downstream glass manufacturing apparatus 30 may be incorporated as part of glass melting furnace 12. For example, first connecting conduit 32 discussed below, or other portions of the downstream glass manufacturing apparatus 30, can be incorporated as part of the glass melting furnace 12.

Downstream glass manufacturing apparatus 30 can include a first conditioning chamber, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of an interior pathway of first connecting conduit 32. Accordingly, first connecting conduit 32 provides a flow path for molten glass 28 from melting vessel 14 to fining vessel 34. However, other conditioning chambers may be positioned downstream of melting vessel 14, for example between melting vessel 14 and fining vessel 34. In some embodiments, a conditioning chamber may be employed between the melting vessel and the fining chamber. For example, molten glass from a primary melting vessel can be further heated in a secondary melting (conditioning) vessel or cooled in the secondary melting vessel to a temperature lower than the temperature of the molten glass in the primary melting vessel before entering the fining chamber.

Bubbles may be removed from molten glass 28 by various techniques. For example, raw material 24 may include multivalent compounds (i.e., fining agents) such as tin oxide that, when heated, undergo a chemical reduction reaction and release oxygen. Other suitable fining agents can include without limitation arsenic, antimony, iron, and/or cerium, although the use of arsenic and antimony, owing to their toxicity, may be discouraged for environmental reasons in some applications. Fining vessel 34 is heated, for example to a temperature greater than the melting vessel interior temperature, thereby heating the fining agent. Oxygen produced by the temperature-induced chemical reduction of one or more fining agents included in the molten glass can diffuse into gas bubbles produced during the melting process. The enlarged gas bubbles with increased buoyancy then rise to a free surface of the molten glass within the fining vessel and can thereafter be vented from the fining vessel, for example through a vent tube in fluid communication with the atmosphere above the free surface.

Downstream glass manufacturing apparatus 30 may further include another conditioning chamber, such as mixing apparatus 36, for example a stirring vessel, for mixing the molten glass that flows downstream from fining vessel 34. Mixing apparatus 36 may be used to provide a homogenous glass melt composition, thereby reducing chemical and/or thermal inhomogeneities that may otherwise exist within the molten glass exiting the fining vessel. As shown, fining vessel 34 may be coupled to mixing apparatus 36 by way of a second connecting conduit 38. Accordingly, molten glass 28 can be gravity fed from the fining vessel 34 to mixing apparatus 36 through an interior pathway of second connecting conduit 38. For instance, gravity may drive molten glass 28 from fining vessel 34 to mixing apparatus 36. Typically, the molten glass within mixing apparatus 36 includes a free surface, with a free (e.g., gaseous) volume extending between the free surface and a top of the mixing apparatus. While mixing apparatus 36 is shown downstream of fining vessel 34 relative to a flow direction of molten glass 28, mixing apparatus 36 may be positioned upstream from fining vessel 34 in other embodiments. In some embodiments, downstream glass manufacturing apparatus 30 may include multiple mixing apparatus, for example a mixing apparatus upstream from fining vessel 34 and a mixing apparatus downstream from fining vessel 34. When used, multiple mixing apparatus may be of the same design, or they may be of a different design from one another. One or more of the vessels and/or conduits may include static mixing vanes positioned therein to promote mixing and subsequent homogenization of the molten material.

Downstream glass manufacturing apparatus 30 may further include another conditioning chamber such as delivery vessel 40 located downstream from mixing apparatus 36. Delivery vessel 40 can act as an accumulator and/or flow controller to adjust and/or provide a consistent flow of molten glass 28 to forming body 42 by way of exit conduit 44. The molten glass within delivery vessel 40 can, in some embodiments, include a free surface, wherein a free volume extends upward from the free surface to a top of the delivery vessel. As shown, mixing apparatus 36 can be coupled to delivery vessel 40 by way of third connecting conduit 46. In some examples, molten glass 28 can be gravity fed from mixing apparatus 36 to delivery vessel 40 through an interior pathway of third connecting conduit 46.

Downstream glass manufacturing apparatus 30 may further include forming apparatus 48 comprising the above-referenced forming body 42, including inlet conduit 50. Exit conduit 44 can be positioned to deliver molten glass 28 from delivery vessel 40 to inlet conduit 50 of forming apparatus 48. Forming body 42 in a fusion down-draw glass making apparatus can comprise a trough 52 positioned in an upper surface of the forming body, and opposing converging forming surfaces 54 that converge in a draw direction 56 along a bottom edge (root) 58 of the forming body. Molten glass delivered to forming body trough 52 via delivery vessel 40, exit conduit 44 and inlet conduit 50 overflows the walls of trough 52 and descends along the converging forming surfaces 54 as separate flows of molten glass. The separate flows of molten glass join below and along the root 58 to produce a ribbon 60 of molten glass that is drawn in draw direction 56 from root 58 by applying a downward tension to the glass ribbon, such as by gravity and/or counter-rotating and opposing pulling rolls. The downward tension and the temperature of the molten material can be used to control dimensions of the ribbon (hereafter glass ribbon) as the molten material cools and a viscosity of the material increases. Accordingly, glass ribbon 60 goes through a viscosity transition, from a viscous state to a viscoelastic state to an elastic state and acquires mechanical properties that give glass ribbon 60 stable dimensional characteristics. Glass ribbon 60 may be separated into shorter lengths, such as into glass sheets 62, by a glass separating apparatus 64. Alternatively, the glass ribbon may be spooled.

Components of downstream glass manufacturing apparatus 30, including any one or more of connecting conduits 32, 38, 46, fining vessel 34, mixing apparatus 36, delivery vessel 40, exit conduit 44, or inlet conduit 50 may be formed from a precious metal. Suitable precious metals include platinum group metals selected from the group consisting of platinum, iridium, rhodium, osmium, ruthenium and palladium, or alloys thereof. For example, downstream components of the glass manufacturing apparatus may be formed from a platinum-rhodium alloy including from about 70% to about 90% by weight platinum and about 10% to about 30% by weight rhodium.

For certain components of the glass manufacturing apparatus, particularly those metal components operated at high temperature, e.g., in excess of about 1300° C., for example in excess of 1400° C., in excess of about 1500° C., in excess of about 1600° C., or even in excess of about 1700° C., but less than the melting point of the metal component, structural integrity of the component may be compromised by the high temperature to which the component is subjected and the thinness of the component. That is, platinum, and other platinum group metals (and/or alloys thereof), are expensive. Accordingly, components incorporating these metals (e.g., including any one or more of connecting conduits 32, 38, 46, fining vessel 34, mixing apparatus 36, delivery vessel 40, exit conduit 44, or inlet conduit 50) are made with thin walls to reduce expense, e.g., having a thickness equal to or less than about 0.254 cm. Pure platinum, for example, has a melting temperature of 1768° C. In some optical-quality glass making apparatus, such as those intended for alumino-silicate glasses such as glass substrates used in the manufacture of optical display devices, a platinum-containing component may be operated in excess of 1600° C., or even in excess of 1700° C., very near the melting temperature of platinum. One such example is the fining vessel, a specialized metal conduit used to remove gases (e.g., bubbles) from the molten glass. The fining vessel is operated partially unfilled. That is, a gaseous atmosphere is maintained over a free surface of the molten glass, providing a region within the fining vessel where gases removed from the molten glass can accumulate and be vented from the fining vessel. However, at least because this gaseous atmosphere is less efficient at eliminating heat from the fining vessel than the molten glass in contact with the lower portion of the fining vessel, the upper portion of the fining vessel may become hotter than the lower portion. Additionally, the gaseous atmosphere provides less mechanical and/or hydraulic support than a comparable conduit completely filled with molten glass. Over time, gravity may cause the upper portion of the fining vessel to slump downward, narrowing the internal passageway of the fining vessel. This collapse can lead to increased resistance to the flow of molten glass through the fining vessel and possible structural failure thereof (e.g., a breach of the fining vessel). Other vessels, e.g., connecting conduits described herein, may also suffer from such outcomes for these or other reasons.

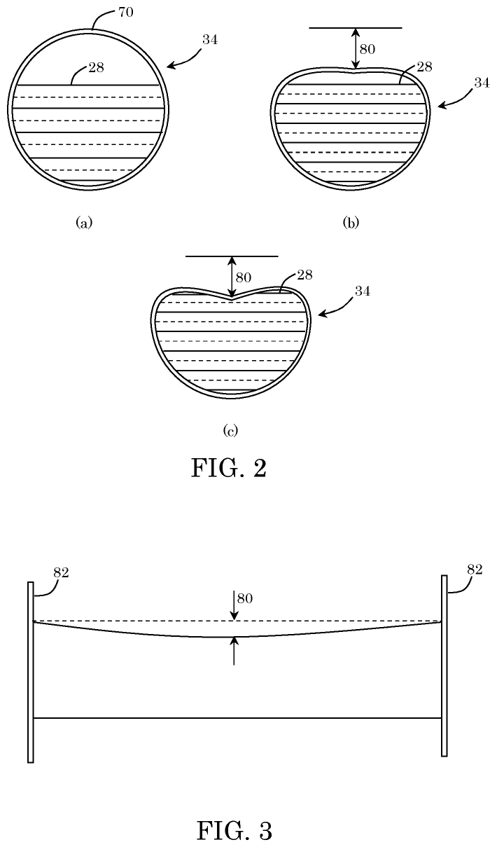

By way of example, FIG. 2 depicts multiple cross-sectional views of an exemplary fining vessel 34 (in a plane orthogonal to a longitudinal axis) shown at multiple points in time, e.g., (a) at the beginning of a melting operation, and (b) and (c) after an extended time in operation, for example after 10,000 hours of operation. FIG. 3 is a longitudinal cross-sectional view of the fining vessel of FIG. 2. The exemplary fining vessel 34 in FIG. 2, view (a) is depicted comprising a wall 70 defining an initial circular cross-sectional shape. However, the fining vessel could have other initial cross-sectional shapes, such as an elliptical shape, an oval shape, or another curvilinear shape. The figures illustrate a downward displacement 80 of the upper portion of the fining vessel in FIG. 2, view (b), after an extended time (e.g., 10,000 hours) of operation at the molten glass processing temperature. In some instances, as depicted in FIG. 2, view (c), downward displacement may be sufficiently large that the collapsed top of the fining vessel contacts the molten glass conveyed therein. In the view of FIG. 3, ends of the fining vessel are supported by electrical flanges 82, positioned at and attached to the ends, preventing collapse of fining vessel 34 at the supported ends such that maximum displacement occurs at or near the unsupported middle of the fining vessel, farthest from the electrical flanges. Autopsies conducted on fining vessels taken out of service have shown collapses of the upper portion in a range from about 18 millimeters (mm) to greater than 24 mm are possible over long periods of high temperature operation. As suggested by FIG. 2, view (c), if collapse of the top of the finer is sufficiently large, the top of the finer may contact the molten glass within the finer. Proper operation of the finer relies on maintaining a volume free of molten glass within the finer and above a free surface of molten glass that forms a reservoir in which gases removed from the molten glass can accumulate and be vented from the finer. The venting relies on free gaseous communication throughout this upper molten glass-free volume of the finer, for example between two electrical flanges. If, for example, a vent is located at one end of the finer, and finer collapse results in the finer top wall contacting the molten glass, this contact may isolate one portion of the molten glass-free volume from another portion of the molten glass-free volume, thereby preventing the free flow of gases through the molten glass-free volume and preventing venting of accumulated gasses. That is, collapse of the upper wall portion of the finer into contact with the molten glass can form isolated pockets of gas within the finer that are cut off from the finer vent and therefore unable to escape the finer. Such trapped gas can redissolve into the molten glass or build up pressure within the finer that leads to failure of the vessel.

Previous attempts at supporting the upper portion of molten glass-conveying conduits has included metal tabs welded to the exterior of the conduit and anchored in supporting refractory material. However, these attempts did not prevent collapse, as placement of the tabs may not prevent collapse between tabs. Moreover, the tabs made movement of the conduit within the surrounding refractory due to thermal expansion and contraction difficult if not impossible, leading to stress failure of the conduit, and loss of refractory material due to a molten glass leaks can destroy the functionality of the tabs anchored therein. To mitigate collapse and extend the life of molten glass-conveying metal components, these components may be strengthened by adding reinforcing members as described herein below.

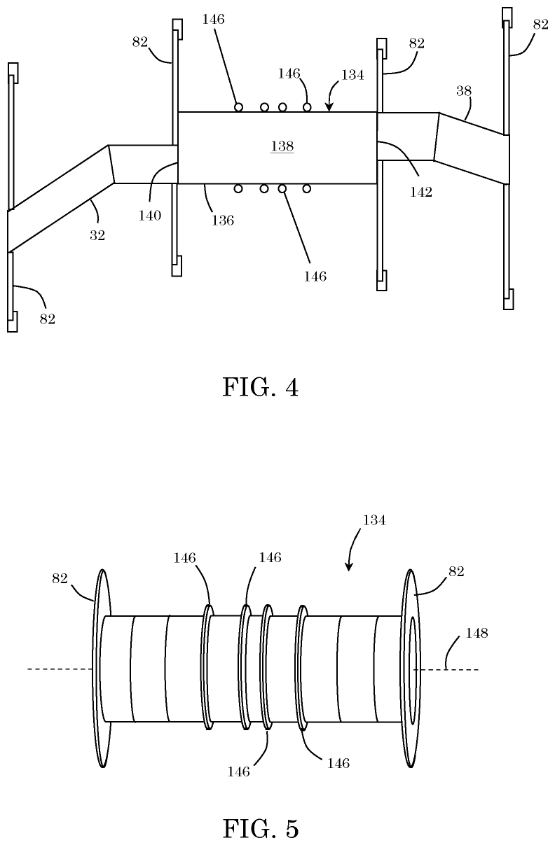

Referring now to FIG. 4, a cross-sectional side view of an exemplary fining vessel 134 is shown that may be used in place of fining vessel 34 in the apparatus of FIG. 1. Fining vessel 134 comprises a wall 136 defining an interior passage 138 extending therethrough between an inlet 140 and an outlet 142 of the fining vessel. A cross-sectional shape of fining vessel 134 may be circular, elliptical, oval, or any combination of curved and optionally planar shapes. Inlet 140 of fining vessel 134 is coupled directly or indirectly to first connecting conduit 32 and outlet 142 is coupled directly or indirectly to second connecting conduit 38. A plurality of electrical flanges 82 are attached to fining vessel wall 136 about a perimeter thereof, such as by welding. The electrical flanges are metallic structures in electrical communication with an electrical current source (not shown) such that an electrical current can be established through fining vessel wall 136 between the electrical flanges 82. The electrical power source may be an alternating current (AC) power source. Electrical flanges typically comprise one or more metal rings attached to an outer surface of the conduit (e.g., fining vessel) wall. If more than one ring, the rings may form concentric rings about the conduit. The concentric rings may be co-planar. Rings may be of different thicknesses. Inner rings, e.g., an innermost ring, may be formed from the same material as the conduit, e.g., platinum or a platinum-rhodium alloy including from about 70% to about 90% by weight platinum and about 10% to about 30% by weight rhodium. Inner rings may be thinner than outer rings. An outermost ring, located farther from the high temperature of the conduit than the inner rings, may be formed from a less temperature resistant metal such as nickel. Thus, fining vessel 134 may be directly heated by resistance (Joule) heating of the fining vessel wall. Additional electrical flanges 82 may also be attached to other conduits, for example first and second connecting conduits 32 and 38, in a manner similar to fining vessel 34.

Electrical flanges 82 may be used to divide fining vessel 134, or any other conduit, into temperature zones, wherein the electrical current between adjacent electrical flanges can be controlled to obtain a predetermined temperature of the molten glass within the conduit between the adjacent flanges. As used herein, adjacent electrical flanges refers to a pair of electrical flanges wherein no additional electrical flange exists between the pair of adjacent flanges. However, one electrical flange may simultaneously serve as one of a first pair of adjacent electrical flanges and one of a second pair of adjacent electrical flanges. While two electrical flanges 82 are shown joined to fining vessel 134 in FIG. 4, fining vessel 134 may include more than two electrical flanges, such as three electrical flanges, four electrical flanges, five electrical flanges, or more. The same or different magnitude of electrical current may be established between each pair of adjacent electrical flanges such that each section of the fining vessel may be controlled to a different temperature.

Fining vessel 134 further comprises at least one reinforcing member 146 attached to an outer surface of fining vessel wall 136. The reinforcing member functions to support an upper portion of a conduit, for example a fining vessel, and prevent collapse of the conduit over an extended time at high operating temperatures. The at least one reinforcing member 146 may be a hollow metal tube attached to the fining vessel wall, such as by welding. The welding need not be continuous. For example, the at least one reinforcing member may be spot welded, or stitch welded, wherein spots or short sections of weld are separated by gaps in the weld. The reinforcing member may be orthogonal to a central longitudinal axis 148 of fining vessel 134 (see FIG. 5). The at least one reinforcing member 146 may be formed from a precious metal. Suitable precious metals include platinum group metals selected from the group consisting of platinum, iridium, rhodium, osmium, ruthenium and palladium, or alloys thereof. For example, the at least one reinforcing member 146 may be formed from a platinum-rhodium alloy including from about 70% to about 90% by weight platinum and about 10% to about 30% by weight rhodium.

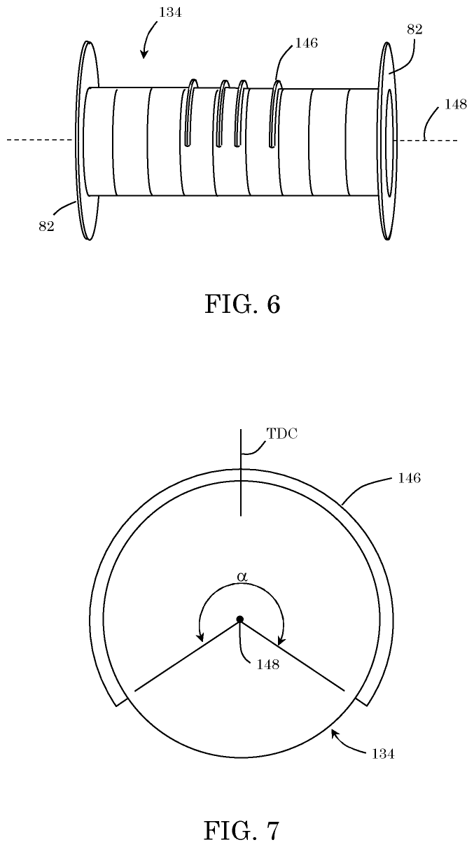

The at least one reinforcing member 146 may extend partially or completely around the fining vessel. For example, assuming a fining vessel with a circular cross-sectional shape, in such a circumstance the at least one reinforcing member 146 may comprise a circular reinforcing member attached to the outer surface of fining vessel wall 136 that extends completely around fining vessel 134 (FIG. 5) or a circular arc that extends around a portion of fining vessel 134 (FIGS. 6-7). If a cross-sectional shape of fining vessel 134 is non-circular, the at least one reinforcing member 146 may have a similar, complimentary shape as the fining vessel. For example, if the perimeter of fining vessel 134 has an oval shape, a shape of an internal perimeter of the at least one reinforcing member 146 may also be oval.

As illustrated in FIG. 7, in the instance where the at least one reinforcing member 146 extends about a portion of fining vessel 134, the at least one reinforcing member 146 may be in the shape of a circular arc (for a circular fining vessel) that subtends an angle α (relative to a center longitudinal axis 148, or equivalent) secured to the outer surface of the fining vessel wall by welding. As depicted in FIGS. 6-7, the at least one reinforcing member is positioned over and along the upper portion of the fining vessel. Angle α can be in a range from about 360 degrees to about 180 degrees, symmetrically arranged about a top dead center (TDC) of fining vessel 134.

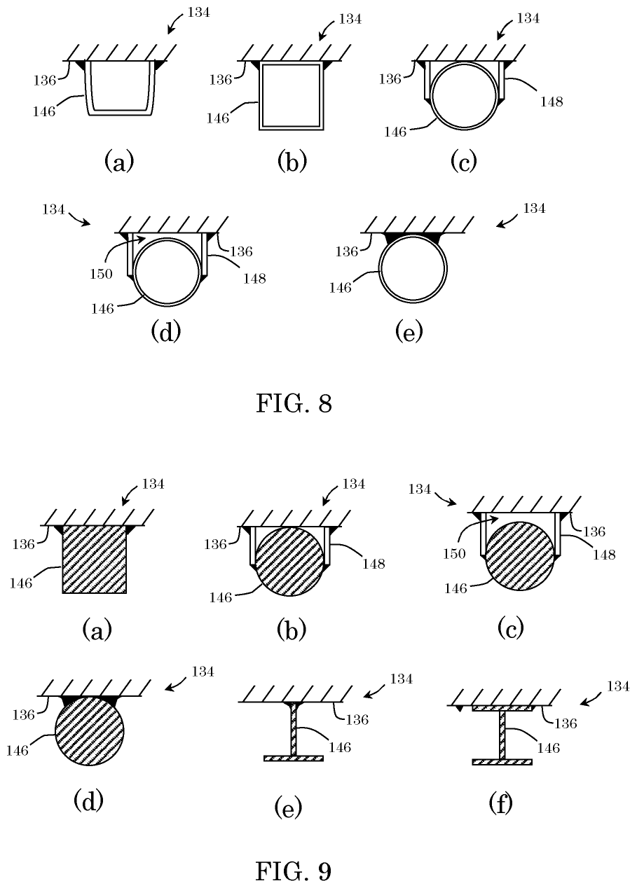

FIG. 8 shows various non-exclusive cross-sectional shapes suitable for the at least one reinforcing member 146. For example, the at least one reinforcing member 146 may be a U-shaped channel with a rectangular or substantially rectangular cross-sectional shape, as shown in FIG. 8, view (a), wherein the U-shaped channel is attached to fining vessel wall 136 with the channel side of the reinforcing member facing the fining vessel wall, thereby forming a hollow interior to the reinforcing member. FIG. 8, view (b), shows another reinforcing member wherein the reinforcing member is a box-shaped tube with four orthogonal sides defining a hollow interior, the box-shaped tube being attached to the fining vessel wall along one side of the box-shaped tube. The box-shaped tube can be a rectangular tube or a square tube. As depicted in FIG. 8, view (c), the at least one reinforcing member can be a hollow cylindrical tube (i.e., with a circular cross-sectional shape). The hollow cylindrical tube may be affixed to the fining vessel wall by a pair of side plates 148 extending alongside the hollow cylindrical tube, wherein each side plate 148 is welded to fining vessel 134 along a first edge of the side plate and welded to the hollow cylindrical tube along the opposing second edge of the side plate. The width of each side plate 148 from the first edge to the second edge can be used to control the distance between the hollow cylindrical tube and fining vessel 134. For example, the hollow cylindrical tube may be positioned in direct contact with fining vessel 134 as shown in FIG. 8, view (c). However, the hollow cylindrical tube may be spaced from the fining vessel by a gap 150 as depicted in FIG. 8, view (d). On the other hand, FIG. 8, view (e) illustrates a hollow cylindrical tube welded directly to the fining vessel without the use of side plates 148. While FIG. 8, views (a)-(e), shows several exemplary reinforcing member cross-sectional shapes suitable for reinforcing fining vessel 134, other shapes are contemplated, including without limitation oval or oblong cross-sectional shapes and polygonal cross-sectional shapes having less than four sides (e.g., triangular cross-sectional shapes) or more than four sides (e.g., pentagonal, hexagonal, heptagonal, octagonal, etc.). Any one of these various cross-sectional shapes may be attached to fining vessel 134 using side plates 148, with or without a gap 150.

Alternatively, or in addition, the at least one reinforcing member 146 attached to fining vessel 134 may be a solid reinforcing member having a cross-sectional shape similar to or identical to the shapes described in respect of FIG. 8, views (a)-(e). For example, FIG. 9, views (a)-(f), depicts (a) a rectangular (e.g., square) member, (b) a cylindrical bar attached with plates with no gaps between the cylindrical bar and the conduit wall, (c) a cylindrical bar attached with plates with a gap between the cylindrical tube and the conduit wall, (d) a cylindrical bar attached without plates, (c) a “T”-shaped reinforcing member, and (f) an “I” shaped reinforcing member, any one or more of which may be substituted for a hollow reinforcing member. Reinforcing members may be mixed, wherein multiple reinforcing members are provided, at least one reinforcing members being hollow and at least one reinforcing members being solid. Other shapes are contemplated, including without limitation oval or oblong cross-sectional shapes and polygonal cross-sectional shapes having less than four sides (e.g., triangular cross-sectional shapes) or more than four sides (e.g., pentagonal, hexagonal, heptagonal, octagonal, etc.). Any one of these various solid cross-sectional shapes may be attached to fining vessel 134 using side plates 148, with or without a gap 150.

To prevent over-pressurization of the at least one reinforcing member due to expansion of gas within a hollow interior of the reinforcing member, such as during heating up of fining vessel 134, the at least one reinforcing member 146 may be provided with one or more pressure equalization orifices 152, the one or more pressure equalization orifices extending between a hollow interior of the reinforcing member and the external atmosphere. Over-pressurization of the at least one reinforcing member 146 can result in bursting of the reinforcing member and damage to fining vessel 134. If the reinforcing member does not extend completely around the fining vessel, the reinforcing member may be open-ended, wherein the pressure equalization orifices may comprise the open ends of the tube or channel (where the reinforcing member comprises a U-shaped member, the pressure equalization orifices may comprise gaps in the weld if stitch or spot welding is used and the gaps in the weld extend between the hollow interior of the U-shaped member and the atmosphere outside the reinforcing member).

As shown in FIG. 9, fining vessel 134 may include creases (e.g., corrugations, crimps) 154 extending around wall 136 of the fining vessel. Creases 154 may provide additional support to the fining vessel wall to prevent collapse of the upper portion of the wall. Each crease may extend completely around fining vessel 134.

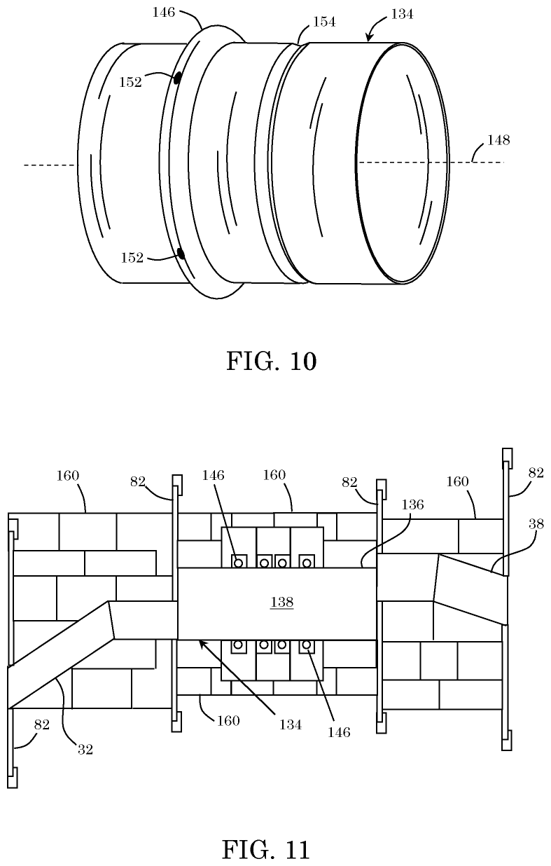

The number and dimensional characteristics of the at least one reinforcing member 146 are dependent on the structural characteristics of the conduit (e.g., fining vessel 134) to which the at least one reinforcing member is attached. For example, the number and dimensional characteristics of the at least one reinforcing member 146 may depend on the length of the conduit, the thickness of the conduit wall or walls, the diameter of the conduit, the physical support provided to the conduit, either by anchors or other supporting structures such as refractory bricks or blocks, and the amount of deformation (e.g., downward displacement of the top of the conduit) that can be tolerated. As shown in FIG. 10, fining vessel 134 (or any other conduit, e.g., connecting conduits) may be supported by refractory material disposed about the conduit. For example, the conduit can be set within refractory sheets, refractory blankets, refractory blocks, a castable refractory material (the castable refractory material being poured as a slurry, then hardened about the conduit), or any combinations of these support materials. Such support materials can include mullite, insulating firebrick, and insulating board (e.g., Fiberfrax® Duraboard® 3000), and are arranged to help control heat loss from the conduit. FIG. 10 shows fining vessel 134 supported by refractory blocks 160, although other forms of refractory material as described above may be used, either alternatively or in addition. However, the use of reinforcing members 146 may prevent collapse of a conduit even in the absence of supporting refractory materials. Thus, to allow movement of the conduit within the refractory material during thermal excursions, the use of a form-fitting castable refractory material may be avoided and a gap be configured between the refractory material and the wall of the conduit. The gap allows free movement of the conduit and reinforcing member within the surrounding refractory material, such as might occur during thermal expansion or contraction of the conduit.

The at least one reinforcing member 146 may comprise a plurality of reinforcing members. For example, fining vessel 134 may have at least two reinforcing members attached thereto, such as three reinforcing members, four reinforcing members, five reinforcing members, six reinforcing members, or more than six reinforcing members. The plurality of reinforcing members 146 may be evenly spaced from one another, or unevenly spaced. There may be a first plurality of reinforcing members attached to the fining vessel between a first pair of adjacent electrical flanges 82, a second plurality of reinforcing members attached to fining vessel 134 between a second pair of adjacent electrical flanges 82, a third plurality of reinforcing members 146 attached to fining vessel 134 between a third pair of adjacent electrical flanges 82, and so forth.

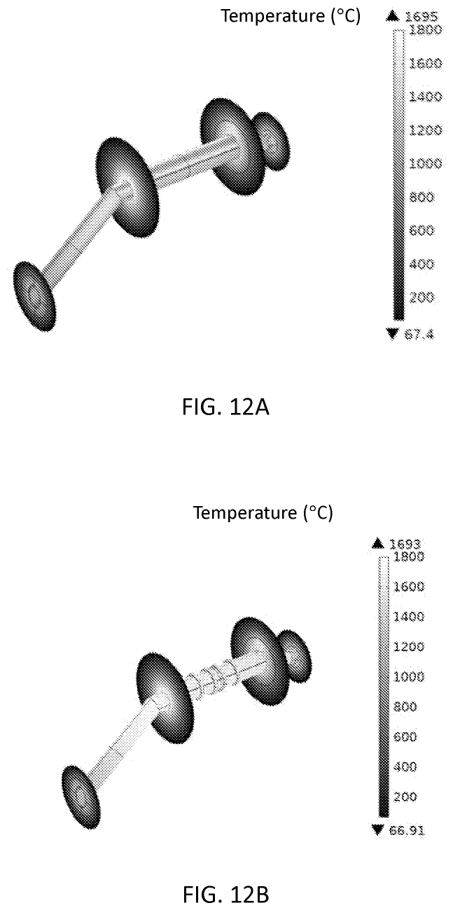

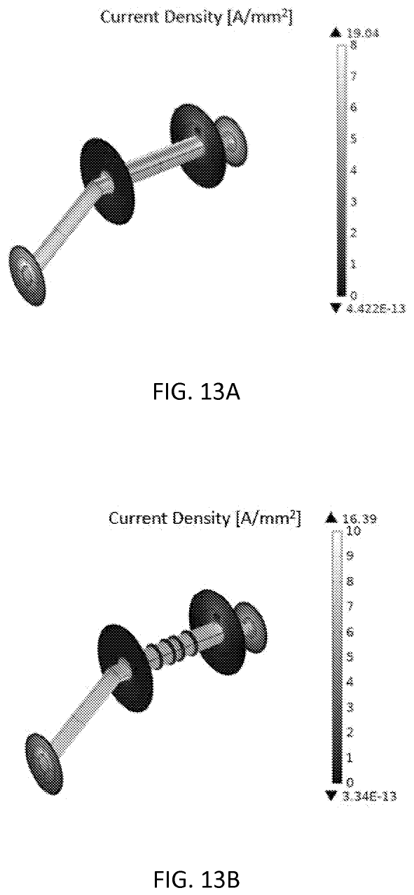

Reinforcing members 146 disclosed herein are spaced apart from the electrical flanges and accordingly play little, if any, part in distribution of electrical current within fining vessel wall 136. Modeling has shown that the presence of reinforcing members spaced apart from electrical flanges do not affect electrical current density in the fining vessel wall and thus do not affect heat generation in the fining vessel wall. FIGS. 11A-11B depict, respectively, modeled results of finer temperature without (FIG. 11A) and with (FIG. 11B) reinforcing members, under otherwise identical conditions. As is readily apparent, no distinguishable difference between the two temperature distributions are apparent. Similarly, FIGS. 12A and 12B depict, respectively, modeled results of finer electrical current density without (FIG. 12A) and with (FIG. 12B) reinforcing members. Again, no distinguishable difference between the two electrical current density distributions are apparent. Thus, the presence of the reinforcing members spaced apart from the electrical flanges do not change the temperature of the fining vessel and therefore the temperature of the molten glass conveyed therein. Put another way, in some glass manufacturing apparatus, fining vessels may include thickened wall portions abutting the electrical flanges. For example, electrical flanges may be connected to the electrical current source by electrode portions that extend from a body of the electrical flange. Electrical current enters the fining vessel wall through the electrode portion and, without mitigation, follows the shortest electrical path through the fining vessel wall. If, for example, the electrode portions are arranged to extend from a top of the electrical flange, the shortest electrical path between two adjacent electrical flanges is across the top of the fining vessel. As previously described a fining vessel utilizes a gaseous atmosphere within the fining vessel (overtop the molten glass). The gaseous atmosphere within the fining vessel has a lower heat capacity and lower thermal conduction than the molten glass, and the high electrical current density at the top of the fining vessel may overheat the top of the fining vessel and cause deterioration of the fining vessel wall. Accordingly, thickened wall portions of the fining vessel positioned abutting the electrical flanges can be used to redistribute electrical current within the fining vessel wall and therefore reduce the temperature of the upper portion of the fining vessel wall. Being spaced apart from the electrical flanges, reinforcing members 146 are ineffective for directing electrical current and/or affecting the temperature of the fining vessel. Typically, reinforcing members 146 disclosed herein may be arranged within a central portion of the fining vessel, e.g., between and spaced apart from two adjacent electrical flanges, such as midway between a pair of adjacent electrical flanges.

While reinforcing members disclosed herein have been described primarily in terms of fining vessels, the disclosed reinforcing members 146, in all of their various shapes and arrangements, may be used on any metallic conduit configured to convey molten glass that may be subject to collapse, including whether or not electrical flanges may be present on the conduit. For example, any of the disclosed connecting conduits 32, 36, and 46 may be provided with reinforcing members 146.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

1. A glass forming apparatus, comprising:
a conduit comprising an interior passage configured to carry a flow of molten glass therethrough; and
at least one reinforcing member attached to and extending around at least a portion of an external periphery of the conduit, the reinforcing member positioned between and spaced apart from a pair of adjacent electrical flanges.

2. The glass forming apparatus of claim 1, wherein the at least one reinforcing member extends around an upper portion of the conduit.

3. The glass forming apparatus of claim 1, wherein the at least one reinforcing member extends circumferentially around the conduit.

4. The glass forming apparatus of claim 1, wherein the at least one reinforcing member comprises a plurality of reinforcing members.

5. The glass forming apparatus of claim 1, wherein the at least one reinforcing member comprises a hollow interior.

6. The glass forming apparatus of claim 5, wherein the reinforcing member comprises a pressure equalization orifice providing fluid communication between the reinforcing member hollow interior and an atmosphere external to the reinforcing member.

7. The glass forming apparatus of claim 1, wherein the conduit comprises platinum.

8. The glass forming apparatus of claim 1, wherein the at least one reinforcing member comprises platinum.

9. The glass forming apparatus of claim 1, wherein the conduit comprises a fining vessel.

10. The glass forming apparatus of claim 1, wherein the at least one reinforcing member is attached to the conduit by plates.

11. The glass forming apparatus of claim 1, wherein the at least one reinforcing member is spaced apart from the conduit by a gap.

12. The glass forming apparatus of claim 1, wherein a cross-sectional shape of the at least one reinforcing member is rectangular or circular.

13. A glass forming apparatus, comprising:
a fining vessel comprising an interior passage and configured to carry a flow of molten glass through the interior passage; and
at least one reinforcing member attached to and extending around at least a portion of an external periphery of the fining vessel, the at least one reinforcing member positioned between and spaced apart from a pair of adjacent electrical flanges attached to the fining vessel.

14. The glass forming apparatus of claim 13, wherein the at least one reinforcing member extends circumferentially around the fining vessel.

15. The glass forming apparatus of claim 13, wherein the fining vessel comprises platinum.

16. The glass forming apparatus of claim 13, wherein the at least one reinforcing member comprises platinum.

17. The glass forming apparatus of claim 13, wherein the at least one reinforcing member comprises a hollow interior.
